(19) United States
(12) Patent Application Publication
(10) Pub. No.: US 2022/0118357 A1
(43) Pub. Date: Apr. 21, 2022

(54) INTERACTIVE VIDEO STREAMING APPARATUS AND METHOD

(71) Applicants: Saj Muzaffar, Hounslow (GB); Morgan Mark Lies, New Rockford, ND (US)

(72) Inventors: Saj Muzaffar, Hounslow (GB); Morgan Mark Lies, New Rockford, ND (US)

(21) Appl. No.: 17/477,033

(22) Filed: Sep. 16, 2021

(30) Foreign Application Priority Data
Oct. 19, 2020 (GB) 2016548.6

(51) Int. Cl. A63F 13/355; H04N 21/2187; H04N 21/478; H04N 21/414; H04N 21/858

(52) U.S. Cl. CPC A63F 13/355; H04N 21/2187; H04N 21/8586; H04N 21/41407; H04N 21/4781

(57) ABSTRACT

An interactive multi-player game for two or more users on their mobile devices responding to a live stream video on a separate video streaming device. An interactive video streaming apparatus includes a game server configured to synchronously transmit live stream video data signals and game play data signals via different first and second communication channels, respectively. A video streaming interface transmits the live stream video data signals to a plurality of streaming devices for broadcasting a live stream video. A mobile device interface is configured to transmit the game play data signals to the plurality of mobile devices, separate from the plurality of streaming devices. Accordingly, the mobile device interface is also configured to receive return signals from the mobile devices in response to questions broadcast on the live stream video.

### CROSS-REFERENCE TO RELATED APPLICATIONS

This application claims This application claims priority to United Kingdom Patent Application Number GB2016548.6, filed Oct. 19, 2021, the disclosure of which is incorporated by reference in its entirety.

### FIELD

The present invention relates to a game apparatus and a method of playing games, and relates particularly but not exclusively to apparatus for multi-player games with two or more mobile devices. The invention relates particularly but not exclusively to games played on a video streaming device.

### BACKGROUND

Interactive games played on a TV including smart TVs, set-top boxes, streaming devices and games consoles are conventionally played by a player controlling play with buttons, roller-ball, a joystick or other selecting or pointing device via a remote control.

Some interactive games have a multiple player facility; however these games require the players to play by turn as there is only one remote control. This prevents competition in real time between the players and hence much of the competitive fun element of the game is lost.

This limitation is inherent: existing interactive games are only designed to work with one remote control. It would be expensive to provide additional equipment allowing multiple remote control support.

Accordingly, it would be desirable to provide a low cost interactive gaming experience to streaming services available on smart TV's, streaming devices or the like by means of one or more smartphones.

### SUMMARY

Accordingly, in a first aspect the invention provides an interactive video streaming apparatus. The apparatus includes a game controller provided on a game server configured to synchronously transmit live stream video data signals and game play data signals via different first and second communication channels, respectively, a video streaming interface to transmit the live stream video data signals to a plurality of streaming devices for broadcasting a live stream video, and a mobile device interface configured to transmit the game play data signals to a plurality of mobile devices, separate from the plurality of streaming devices. The mobile device interface is also configured to receive return signals from the mobile devices in response to questions broadcast on the live stream video.

An interactive video streaming method is also provided. The method includes synchronously transmitting live stream video data signals and game play data signals from a game server via different first and second communication channels, respectively, transmitting the live stream video data signals via a video streaming interface to a plurality of streaming devices for broadcasting a live stream video, transmitting the game play data signals via a mobile device interface to a plurality of mobile devices, separate from the plurality of streaming devices, and receiving return signals from the mobile devices in response to questions broadcast on the live stream video.

Preferably the signals maybe sent and received between the cloud game server and one or more mobile devices operated by one or more players, such as smartphones or tablets or the like. Such mobile devices normally include a WiFi or data communication means which can send and receive the signals.

Optionally the signals are encrypted so that even if they are intercepted by a user, no information can be derived until they are processed by a mobile device, this maybe by means of HTTPS.

Preferably the signals are sent and received between the game cloud server and the mobile devices by means of a local network by means of a router (e.g. WiFi) or mobile data (3G, 4G 5G).

Preferably the game play data is synchronized with the encoded live video stream of the website.

Preferably the mobile devices communicate to the cloud gaming server by means of a mobile web browser.

Preferably said mobile processing device is programmed on the cloud server to compare said potential game play with actual game play by a user of said mobile processing device.

In one embodiment, the cloud gaming server puts a question or puzzle to the user in sync to both the Live video stream and mobile browser.

In another embodiment, the cloud gaming service asks the user for the outcome of a game of chance, for example, the number on roulette wheel where the ball will land.

Preferably the gaming apparatus comprises a plurality of such mobile processing devices for use by competing users, the said competing users may be remote from one another and may be in different territories and/or time zones.

In such embodiments the invention provides a low cost solution for a true multiple player interactive game.

The signals received by the mobile devices may for example comprise game play data including but not limited to game, level start and/or end triggers, questions, answers to questions and/or puzzles or the like.

In such embodiments an interactive game can be played by any number of players (simultaneously) with a mobile device running on the mobile device(s) web browser in sync on the website being encoded and streamed.

In a fourth aspect the invention provides a method of playing game wherein signals are generated. The signals encode potential game play by one or more players. The signals are detected by at least one mobile processing device and are decoded to derive said potential game play.

In a fifth aspect of the invention, the means to find a winner of a multi-player game is provided. At the end of a game, every players device sends its score to the cloud game server which is programmed to compare all the players scores and find a winner of the game and notify the players of the winner(s) and looser(s) of the game by sending either a winner or loser signal back to the players devices and to the website.

A screen initiating game play, e.g. by displaying a question or puzzle, may for example be displayed in sync on the streaming device and on a display of the mobile device.

In a preferred embodiment, the cloud game server is arranged to receive user interaction data via Wifi signals and/or mobile data (e.g. 3G, 4G, 5G) from the said mobile devices.

The mobile device game played on the mobiles web browser may be designed so that a correct answer awards a player points.

Additionally or alternatively each player may be scored according to the speed of correctly answering a question being displayed.

The system may be arranged so that many players can compete against one another during a game. In this case each player may be scored according to his or her accuracy and/or speed of answering questions. Each player's score may then be transmitted back to the cloud gaming server in order to find a winner.

In another embodiment of the invention the streaming device may be a Single-board computer. (eg. Raspberry Pi or the like).

The game may for example be a game show, trivia, board game or a puzzle based game, It may, for example, be a game of skill, chance, tournament or a combination thereof.

Some example embodiments will be described in greater detail with reference to the accompanying drawings. Other aspects of the disclosed interactive video streaming apparatus and method will become apparent from the following detailed description, the accompanying drawings and the appended claims.

### BRIEF DESCRIPTION OF THE DRAWINGS

Preferred embodiments of the invention are described below by way of example only with reference to FIG. 1 of the accompanying drawings, wherein:

FIG. 1 is a schematic diagram in accordance with an example embodiment of the present disclosure.

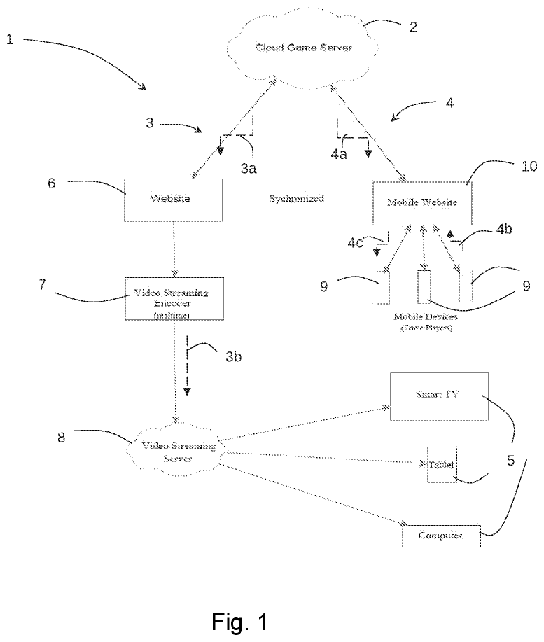

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

While the present teachings are described in conjunction with various embodiments and examples, it is not intended that the present teachings be limited to such embodiments. On the contrary, the present teachings encompass various alternatives and equivalents, as will be appreciated by those of skill in the art.

An interactive video streaming apparatus 1 includes at least one game controller or processor provided on a game server 2, such as a cloud game server, configured to transmit and receive over two, i.e. first and second, synchronised communication channels 3 and 4. The at least one game controller or processor may comprise suitable computer hardware and/or computer software, and at least one non-transitory memory device that is configured to store the computer software executable by the at least one game controller or processor, and relating to the operation of at least one game, contest or retail store, including the transmission and reception of control and game signals.

The first communication channel 3 may be connected to a streaming service, such as a live stream or near live stream system for streaming live stream content signals 3b to streaming devices 5, such as smart TV's, tablets, consoles, computers, set-top boxes or the like. Preferably each streaming device 5 is arranged to display the streaming service, e.g. YouTube.

The first communication channel 3 may comprise a live streaming interface including a streaming website 6, stored in any suitable server, and configured to receive and transmit game play content signals 3a transmitted from the game server 2, which may be encoded into the live stream or near live stream content signals 3b by a video stream encoder 7, and streamed to the streaming devices 5 by means of a video streaming server application 8, e.g. YouTube.

The second communication channel 4 includes a game play interface configured for receiving and transmitting game play data signals 4a between the game server 2 and a plurality of mobile devices 9 operated by one or more players. The mobile devices 9 may communicate to the game server 2 by means of a mobile website 10 included in the game play interface, and stored in any suitable server. Preferably the game play data signals 4a may be sent and received between the game server 2 and the one or more mobile devices 9 operated by one or more players, such as smartphones or tablets or the like. Such mobile devices 9 normally include a WiFi or data communication circuit which can send and receive the game play data signals 4a via the second communication channel 4. The user may download an interface software application from the mobile website 10, the game server 2 or other suitable location, onto their mobile device 9 to facilitate interaction with the game or contest, e.g. the mobile website 10 or the game server 2. The URL (uniform Resources Locator) of the mobile website 10 synchronized with the streaming video, e.g. live stream content signals 3b, may be displayed as text or a QR code which the user may scan or transmitted by each streaming device 5 to each mobile device 9 by known means, e.g. WiFi, Bluetooth or the like wireless pairing communications.

Optionally the game play data signals 4a may be encrypted so that even if they are intercepted by an unauthorised user, no information can be derived until the game play data signals 4a are processed by the mobile devices 9, this may be by means of HTTPS.

Preferably the game play data signals 4a may be sent and received between the game server 2 and the mobile devices 9 by means of the second communication channel 4 comprising a local network by means of a router, e.g. WiFi or mobile data, e.g. 3G, 4G or 5G.

The game play data signals 4a may be synchronised with the game play content signals 3a and/or the live stream content signals 3b of the steaming website 6.

The mobile devices 9 may be programmed on the game server 2 to compare the potential game play with actual game play by the user of the mobile device 9.

In some embodiments the game server 2 may provide a question or a puzzle to the user via their mobile device 9 in sync with both the live stream content signals 3b of the live video stream and the game play data signals 4a of the mobile browser 10.

In some embodiment the game server 2 may provide a question to the user via their mobile devices 9 for the outcome of a game of chance, for example the number on roulette wheel, e.g. where the ball will land, the winner of a contest, etc.

Preferably, the interactive video streaming apparatus 1 is configured to accommodate a plurality of such mobile processing devices 9 for use by competing users. In such embodiments the invention provides a low cost solution for a true multiple player interactive game.

The game play data signals 4a received by the mobile devices 9 may for example comprise game play data including but not limited to game, level, start and/or end triggers, questions, answers to questions, and/or puzzles or the like.

In such embodiments an interactive game may be played by any number of players (simultaneously), each with their mobile device 9 running on the mobile device(s) web browser 10 in sync on the streaming website 6 being encoded and streamed to the streaming devices 5.

In some embodiments, the interactive video streaming apparatus 1 provides a method of playing a game, wherein returning signals 4b are generated by the users on their mobile processing devices 9, the returning signals 4b may encode potential game play by one or more players, and the returning signals 4b may be detected by at least one other mobile processing devices 9 via the mobile browser 10 and/or the game server 2, and decoded by the mobile processing devices 9 to derive said potential game play.

The interactive video streaming apparatus 1 may be configured to determine a winner of a multi-player game, wherein at the end of each question, each round or each game every player's mobile processing device 9 sends the answers or the individual or accumulated score to the game server 2, which is programmed to compare all the players scores and find a winner of the game and notify the players of the winner(s) and looser(s) of the game by sending either a winner or loser signal via the second communication channel 4 back to the player's devices 9 via the mobile website 10.

A screen initiating game play, e.g. by displaying a question or puzzle, may for example be displayed in sync on each streaming device 9 and on a display of each mobile device 5.

In a preferred embodiment the game server 2 is configured to receive game play data signals 4a and/or the returning signal 4b via Wifi signals from each mobile device 9, whereby the second communication channel at least partially comprises a channel in a wireless network. The first and second communication channels 3 and 4 may also comprise, at least in part, a channel in a wired network, e.g. optical network.

The mobile device game played on the mobiles website 10 may be configured so that a correct answer awards a player points via an award signal 4c transmitted from the mobile website 10 to the selected mobile devices 9 via the second communication channel. Additionally or alternatively each player may be scored according to the speed of correctly answering a question being displayed.

The interactive video streaming apparatus 1 may be configured so that many players may compete against one another during a game. In this case each player may be scored according to his or her accuracy and/or speed of answering questions. Each player's score may then be transmitted back to the game server 2 after each question, each round or each game in order to find a winner. The game may for example be a game show, trivia, board game or a puzzle based game. The game may be a game of skill or chance or a combination thereof.

Alternatively, the game play content signals 3a transmitted from the game server 2, which may be encoded into the live stream or near live stream content signals 3b, may include advertising or discussing, voting, chatting, and bidding, articles for sale, such as a shopping channel, and the game play data signals 4a may include a list of articles to purchase, whereby the returning signals 4b may include purchase orders and/or credit card information. The game play data signals 4a may also include bidding, chatting, discussing or voting and are sent back by the mobile device 9 via returning signals 4b. For example, during a live stream auction, a user submits a bid via their mobile device 9 and that bid is then shown on the video streaming service.

The term controller or processor may include a computer processor including computer hardware and computer software executable thereon along with suitable non-transitory memory for storing the computer software. The term circuit may include dedicated hardware or hardware in associated with software executable thereon.

As used in this application, the term “circuit” or “circuitry” may refer to one or more or all of the following:

(a) hardware-only circuit implementations (such as implementations in only analog and/or digital circuitry);
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions); and
   (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The foregoing description of one or more example embodiments has been presented for the purposes of illustration and description. It is not intended to be exhaustive or to limit the invention to the precise form disclosed. Many modifications and variations are possible in light of the above teaching. It is intended that the scope of the disclosure be limited not by this detailed description.

1. An interactive video streaming apparatus comprising:
a game controller provided on a game server configured to synchronously transmit live stream video data signals to a plurality of streaming devices for broadcasting a live stream video, and game play data signals to a plurality of mobile devices, separate from the plurality of streaming devices, via different first and second communication channels, respectively; and
a mobile device interface configured to receive the game play data signals on each mobile device;
wherein the mobile device interface is also configured to send return signals from each mobile device in response to questions broadcast on the live stream video.

2. The apparatus according to claim 1, further comprising a video streaming interface to transmit the live stream video data signals to the plurality of streaming devices for broadcasting a live stream video.

3. The apparatus according to claim 2, wherein the video streaming interface includes a video streaming website for receiving and transmitting video signals from the game controller.

4. The apparatus according to claim 3, wherein the video streaming interface includes a video streaming encoder for converting the video signals into the live stream video data signals, and transmitting the live stream video data signals to a video streaming server for broadcast to the plurality of streaming devices.

5. The apparatus according to claim 1, wherein the mobile device interface includes a mobile device website for receiving and transmitting the game play data signals from the game controller.

6. The apparatus according to claim 1, wherein the live stream video data signals comprise trivia questions.

7. The apparatus according to claim 6, wherein the game play data signals comprise prompts for the trivia questions, whereby the return signals comprise answers to the trivia questions.

8. The apparatus according to claim 7, wherein the game controller is configured to determine whether the answers to each of the trivia questions are correct for each user, calculate a total number of correct answers for each user, compare the total number of correct answers for each user, and determine a winner based on the total number of correct answers for each user.

9. The apparatus according to claim 1, wherein the live stream video data signals comprise one of or any combination of articles for sale, advertising, discussing, voting, chatting, and bidding, wherein the game play data signals comprise one of or any combination of bidding, chatting, discussing and voting.

10. The apparatus according to claim 9, wherein the game play data signals comprise articles of sale, wherein the game play data signals comprise prompts for the articles for sale, whereby the return signals comprise purchase orders for selected articles for sale.

11. An interactive video streaming method comprising:
synchronously transmitting live stream video data signals and game play data signals from a game controller via different first and second communication channels, respectively;
transmitting the live stream video data signals via a video streaming interface to a plurality of streaming devices for broadcasting a live stream video;
transmitting the game play data signals via a mobile device interface to a plurality of mobile devices, separate from the plurality of streaming devices; and
receiving return signals from the mobile devices in response to questions broadcast on the live stream video.

12. The method according to claim 11, wherein the video streaming interface includes a video streaming website for receiving and transmitting video signals from the game controller.

13. The method according to claim 12, wherein the video streaming interface includes a video streaming encoder for converting the video signals into the live stream video data signals, and transmitting the live stream video data signals to a video streaming server for broadcast to the plurality of streaming devices.

14. The method according to claim 11, wherein the mobile device interface includes a mobile device website for receiving and transmitting the game play data signals from the game controller.

15. The method according to claim 11, wherein the live stream video data signals comprise trivia questions.

16. The method according to claim 15, wherein the game play data signals comprise prompts for the trivia questions, whereby the return signals comprise answers to the trivia questions.

17. The method according to claim 16, wherein the game controller is configured to determine whether the answers to each of the trivia questions are correct for each user, calculate a total number of correct answers for each user, compare the total number of correct answers for each user, and determine a winner based on the total number of correct answers for each user.

18. The method according to claim 11, wherein the live stream video data signals comprise one of or any combination of articles for sale, advertising, discussing, voting, chatting, and bidding, wherein the game play data signals comprise one of or any combination of bidding, chatting, discussing and voting.

19. The method according to claim 18, wherein the game play data signals comprise articles of sale, wherein the game play data signals comprise prompts for the articles for sale, whereby the return signals comprise purchase orders for selected articles for sale.

20. The method according to claim 14, further comprising displaying the mobile device website URL in the live video stream as a QR code.
